(19) United States
(12) Patent Application Publication
(10) Pub. No.: US 2023/0344676 A1
(43) Pub. Date: Oct. 26, 2023

(54) METHODS, CONTROL NODE, WIRELESS DEVICE AND ACCESS NODE FOR ESTIMATION OF PATH LOSS AND CHANNEL RESPONSE

(71) Applicant: Telefonaktiebolaget LM Ericsson (publ), Stockholm (SE)

(72) Inventors: Giovanni INTERDONATO, Cassino Frosinone (IT); Pål FRENGER, Linköping (SE); Erik G. LARSSON, Linköping (SE)

(21) Appl. No.: 17/793,238

(22) PCT Filed: Jan. 30, 2020
(86) PCT No.: PCT/SE2020/050077

§ 371 Date: Jul. 15, 2022

(51) Int. Cl. H04L 25/02; H04L 27/26; H04L 5/00

(52) U.S. Cl. CPC H04L 25/0204; H04L 25/0222; H04L 27/261; H04L 5/0048; H04L 25/0224

(57) ABSTRACT

A control node, a wireless device, an access point and methods therein, to achieve estimation of path loss and channel response in a radio link between the wireless device and the access point. The control node assigns one and the same pilot sequence to the wireless device and at least one other wireless device in communication with the access point, and further assigns different device-specific phase rotations to the wireless devices. The devices then apply their assigned phase rotations to the pilot sequence when transmitting the pilot sequence in consecutive coherence intervals to the access point which is thereby able to de-spread the received pilot sequences and estimate path loss and channel response in the radio link.

### TECHNICAL FIELD

The present disclosure relates generally to a control node, a wireless device, an access point and methods therein, to achieve estimation of path loss and channel response in a radio link between the wireless device and the access point.

### BACKGROUND

In this disclosure, the term “wireless device” is used to represent any communication entity capable of radio communication with a wireless network by sending and receiving radio signals, such as e.g. mobile telephones, tablets, laptop computers and Machine-to-Machine, M2M, devices, also known as Machine Type Communication, MTC, devices. Another common generic term in this field is “User Equipment, UE” which is frequently used herein as a synonym for wireless device.

Further, the term “access point”, is used herein to represent any node of a wireless network that is operative to communicate radio signals with wireless devices. The access point in this disclosure may refer to a base station, radio node, Node B, base transceiver station, network node, etc., depending on the terminology used although this disclosure is not limited to these examples.

It is assumed that the access point in this disclosure is capable of performing estimation of path loss and channel response in a radio link between a wireless device and the access point. The estimated path loss and/or channel response are commonly used as a basis for evaluating the radio link and how useful or suitable it is for radio communication. The estimation of path loss and channel response is typically made by access points on a pilot sequence, herein frequently referred to as “pilot” for short, which is transmitted by the wireless devices on prescribed radio resources. An example of how wireless devices transmit respective pilot sequences to an access point as a basis for channel estimation is illustrated in FIG. 1 where one device, denoted UE 1, transmits its assigned pilot 1 while another device, denoted UE 2, transmits its assigned pilot 2.

Typically, each access point has a set of pilot sequences available which can be assigned to different wireless devices in communication with the access point, e.g. wireless devices located in a cell or beam where the access point provides radio coverage. Since the pilot sequences are different from each other, the access point is able to distinguish between the transmissions of pilot sequence when received, and to perform the above path loss and channel response estimation for each individual radio link, based on the respective received pilot.

However, the number of available pilot sequences may be less than the number of wireless devices currently in communication with the access point, which means that there is not enough pilot sequences to assign different ones to all devices.

This could be handled by reusing some of the available pilot sequences for more than one wireless device. As a result, there is a risk that the same pilot is transmitted by two or more wireless devices, e.g. at the same time, which results in interference or so-called “pilot contamination” so that the access point is not able to receive the pilot transmissions in a distinguishable manner. Thereby, the respective radio links cannot be properly evaluated due to poor estimation of path loss and channel response.

### SUMMARY

It is an object of embodiments described herein to address at least some of the problems and issues outlined above. It is possible to achieve this object and others by using a control node, a wireless device, an access point and methods therein, as defined in the attached independent claims.

According to one aspect, a method is performed by a control node of a wireless network, to support estimation of path loss and channel response in radio links between wireless devices and an access point of the wireless network. In this method, the control node assigns a pilot sequence to each wireless device, out of a set of predefined pilot sequences, so that one and the same pilot sequence is assigned to at least two wireless devices. The control node also assigns a device-specific phase rotation to each of the at least two wireless devices so that each wireless device assigned with the same pilot sequence is assigned with a phase rotation that is different than the phase rotation(s) assigned to the other wireless device(s). Thereby, each wireless device is enabled to apply its assigned phase rotation to its assigned pilot sequence when transmitting the pilot sequence in consecutive coherence intervals.

According to another aspect, a control node of a wireless network is arranged to support estimation of path loss and channel response in radio links between wireless devices and an access point of the wireless network. The control node is configured to assign a pilot sequence to each wireless device, out of a set of predefined pilot sequences, so that one and the same pilot sequence is assigned to at least two wireless devices in the set. The control node is further configured to assign a device-specific phase rotation to each of the at least two wireless devices so that each wireless device assigned with the same pilot sequence is assigned with a phase rotation that is different than the phase rotation(s) assigned to the other wireless device(s), thereby enabling each wireless device to apply its assigned phase rotation to its assigned pilot sequence when transmitting the pilot sequence in consecutive coherence intervals.

According to another aspect, a method is performed by a wireless device in communication with an access point of a wireless network, to support estimation of path loss and channel response in a radio link between the wireless device and the access point. In this method, the wireless device obtains a pilot sequence assigned to the wireless device out of a set of predefined pilot sequences, wherein the same pilot sequence is also assigned to at least one other wireless device in communication with said access point. The wireless device also obtains a device-specific phase rotation assigned to the wireless device, said phase rotation being different than a phase rotation assigned to any other wireless device assigned with the same pilot sequence. The wireless device then transmits the obtained pilot sequence in consecutive coherence intervals by applying the obtained phase rotation to the pilot sequence in each coherence interval.

According to another aspect, a wireless device is arranged to support estimation of path loss and channel response in a radio link between the wireless device and an access point of a wireless network when in communication with the access point.

The wireless device is configured to obtain a pilot sequence assigned to the wireless device out of a set of predefined pilot sequences, wherein the same pilot sequence is also assigned to at least one other wireless device in communication with said access point. The wireless device is also configured to obtain a device-specific phase rotation assigned to the wireless device, said phase rotation being different than a phase rotation assigned to any other wireless device assigned with the same pilot sequence. The wireless device is further configured to transmit the obtained pilot sequence in consecutive coherence intervals by applying the obtained phase rotation to the pilot sequence in each coherence interval.

According to another aspect, a method is performed by an access point of a wireless network, when in communication with a wireless device, to achieve estimation of path loss and channel response in a radio link between the wireless device and the access point. In this method, the access point receives a superposition of pilot sequences in consecutive coherence intervals, including a phase-rotated pilot sequence assigned to the wireless device and to at least one other wireless device in communication with said access point. The access point then de-spreads the pilot sequences received in each coherence interval by projecting the pilot sequences on a set of pre-determined orthonormal sequences. The access point further estimates the path loss in the radio link based on the de-spreaded pilot sequences, and estimates the channel response in the radio link based on the estimated path loss.

According to another aspect, an access point of a wireless network is arranged to achieve estimation of path loss and channel response in a radio link between a wireless device and the access point when the access point is in communication with the wireless device. The access point is configured to receive a superposition of pilot sequences in consecutive coherence intervals, including a phase-rotated pilot sequence assigned to the wireless device and to at least one other wireless device in communication with said access point. The access point is further configured to de-spread the pilot sequences received in each coherence interval by projecting the pilot sequences on a set of pre-determined orthonormal sequences. The access point is further configured to estimate the path loss in the radio link based on the de-spreaded pilot sequences, and to estimate the channel response in the radio link based on the estimated path loss.

When using either of the above methods and nodes, it is an advantage that estimations of path loss and channel response can be achieved on the respective radio links with high or at least sufficient quality when a pilot sequence is reused by two or more wireless devices. Further, pilot resources can be saved in the path loss and channel response estimation since path loss can be estimated on the same resources employed for channel response estimation.

The above methods and nodes may be configured and implemented according to different optional embodiments to accomplish further features and benefits, to be described below.

A computer program is also provided comprising instructions which, when executed on at least one processor in either of the above nodes, cause the at least one processor to carry out the respective methods described above. A carrier is also provided which contains the above computer program, wherein the carrier is one of an electronic signal, an optical signal, a radio signal, or a computer readable storage medium.

### BRIEF DESCRIPTION OF DRAWINGS

The solution will now be described in more detail by means of exemplary embodiments and with reference to the accompanying drawings, in which:

FIG. 1 is a diagram illustrating how wireless devices transmit respective pilot sequences 1 and 2 to an access point as a basis for channel estimation, according to prior art.

FIG. 2 is a communication scenario illustrating an example of a procedure when the solution is used, according to some possible embodiments.

FIG. 3 is a flow chart illustrating a procedure in a control node, according to further possible embodiments.

FIG. 4 is a flow chart illustrating a procedure in a wireless device, according to further possible embodiments.

FIG. 5 is a flow chart illustrating a procedure in an access point, according to further possible embodiments.

FIG. 6 is a block diagram illustrating a control node, a wireless device and an access point in more detail, according to further possible embodiments.

FIG. 7 is a communication scenario where channel estimation should be made in different access points for wireless devices based on their pilot transmissions, where the embodiments herein may be used.

FIG. 8 illustrates an example of the scenario in FIG. 7 where two wireless devices, UE₁ and UE₂, are using the same pilot sequence, where the embodiments herein may be used.

FIG. 9 is a diagram illustrating an example where coherence intervals are distributed in the frequency domain, which may be employed when using the embodiments herein.

FIG. 10 is a diagram illustrating an example where coherence intervals are distributed in the time domain, which may be employed when using the embodiments herein.

FIG. 11 is a diagram illustrating an example where coherence intervals are distributed in both the frequency domain and the time domain, which may be employed when using the embodiments herein.

FIG. 12 is a diagram illustrating a transmission scheme where phase shifted pilot sequences are transmitted from two UEs using the same pilot sequence, which may be employed when using the embodiments herein.

FIG. 13 illustrates another example of the scenario in FIG. 7 where two wireless devices, UE₁ and UE₂, are using the same pilot sequence but different phase shift functions, i.e. phase rotations, according to further possible embodiments.

FIG. 14 is a signaling diagram with operations and messages involving a wireless device (UE), an Access Point (AP) and a Central Processing Unit (CPU) to accomplish configuration of the UE and estimation of path loss and channel response

FIG. 15 is a diagram of illustrating how a Normalized Mean Square Error (NMSE) of path loss estimates can be improved by using phase-rotated pilots at each coherence interval as compared to not using phase-rotated pilots.

FIGS. 16-21 illustrate further scenarios, structures and procedures that may be employed when the solution is used, according to further possible embodiments.

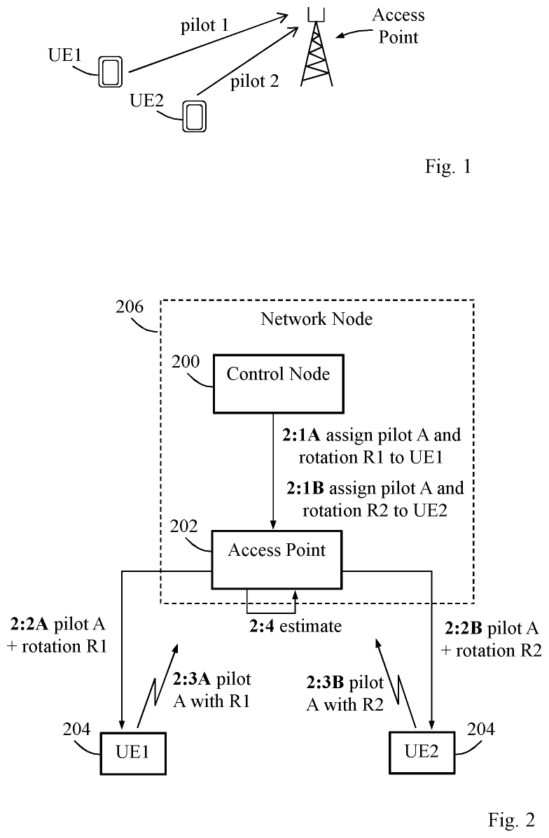

### DETAILED DESCRIPTION

The embodiments described herein may be used in procedures for enabling and performing estimation of path loss and channel response in a radio link between a wireless device and an access point of a wireless network. These embodiments are particularly useful when the number of available pilot sequences is less than the number of wireless devices being in communication with the access point. It is therefore assumed that at least one of the available pilot sequences needs to be reused by assigning it to at least two wireless devices, which means that there is a risk that those devices transmit the same pilot sequence at the same time, as discussed above.

Wireless devices are generally required to transmit their assigned pilot sequences in specific prescribed radio resources which may be defined by time and frequency, typically occurring repeatedly over time in consecutive so-called coherence intervals. The access point will therefore receive a superposition of two or more pilot sequences in a coherence interval which is used by two or more devices for pilot transmission at the same time.

In order to enable the access point to properly distinguish and measure the individual pilot sequences in the received superposition for channel estimation, the embodiments herein let the network, e.g. by means of a control node therein, assign a device-specific phase rotation to each wireless device that share the same pilot sequence. The term “phase rotation” used throughout this disclosure should be understood as a phase shifting function and these two terms are used herein interchangeably.

In more detail, each wireless device is assigned with a phase rotation that is different than the phase rotation(s) assigned to the other wireless device(s) being assigned with the same pilot sequence. Thereby, each wireless device is enabled, i.e. basically configured and instructed by the network, to apply its assigned phase rotation to its assigned pilot sequence when transmitting the pilot sequence in consecutive coherence intervals.

As a result, the access point is able to extract each phase-rotated pilot individually for the different devices by performing a de-spreading operation on the received superposition which may be performed by projecting this received pilot signal onto a set of pre-determined orthonormal pilot vectors. A de-spreading operation on a received superposition of signals by projecting the superposition onto a set of orthonormal vectors can generally be performed in a manner known in this field. An example of how this technique can be applied in the embodiments herein will be described later below.

An example of a communication scenario where the above solution is used is illustrated in FIG. 2 involving a control node 200 and an access point 202 which are comprised in a wireless network. The control node 200 and the access point 202 may be implemented as separate nodes or in a common node which could be a suitable network node, such as a base station or the like, as indicated by a dashed box 206.

In this example, multiple wireless devices are currently in communication with the access point 202 and outnumber the pilot sequences that are available to the access point 202, as described above. In the figure, two wireless devices 204 denoted UE1 and UE2, are shown which will share the same pilot sequence. The access point 202 needs to estimate path loss and channel response in respective links between the devices 204 and the access point 202, typically as a basis for evaluating the radio link and how useful or suitable it is for radio communication.

A first operation 2:1A illustrates that the control node 200 assigns pilot A and phase rotation R1 to UE1 which assignments are transmitted to UE1 by the access point 202 in an operation 2:2A. the control node 200 also assigns the same pilot A but a different phase rotation R2 to UE2 in a further operation 2:1B, which assignments are transmitted to UE2 by the access point 202 in an operation 2:2B.

A next operation 2:3A illustrates that UE1 transmits its assigned pilot A by applying its assigned phase rotation R1. At the same time, e.g. in the same coherence interval used by UE1, UE2 transmits its assigned pilot A by applying its assigned phase rotation R2, in an operation 2:3B. Since UE1 and UE2 apply different phase rotations R1 and R2, respectively, when transmitting pilot A, the access point 202 is able to de-spread the superimposed and phase-rotated pilots by projecting them on a set of pre-determined orthonormal sequences, and further estimate the path loss and channel response in each radio link using the de-spreaded pilot sequences, as indicated by an operation 2:4. It is an advantage that accurate and reliable estimations of path loss and channel response can be made on the respective radio links even when the same pilot is shared and transmitted by two or more wireless devices 204 on the same radio resource occurring in consecutive coherence intervals.

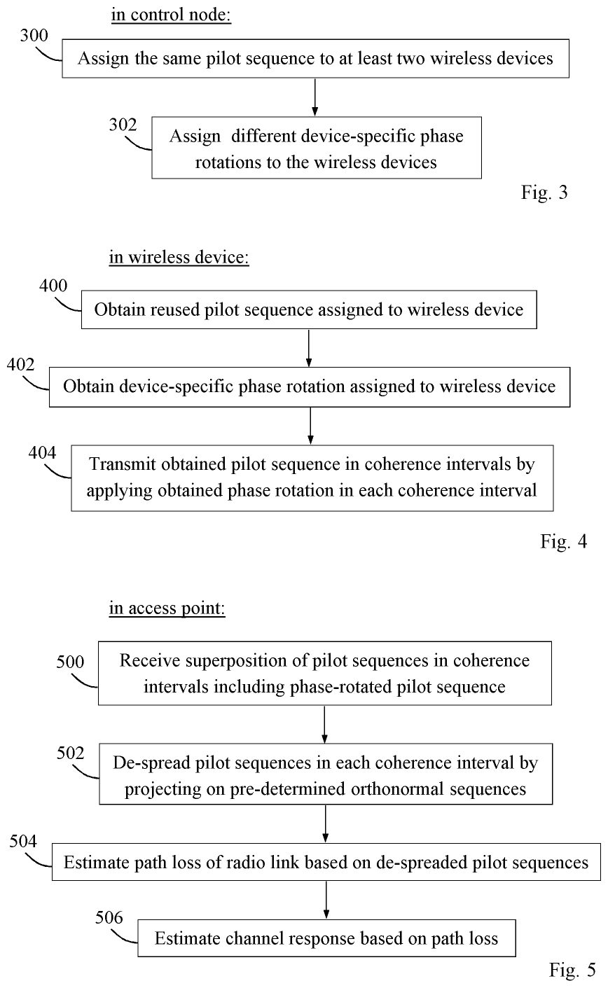

An example of how the solution may be employed in terms of actions performed by a control node such as the control node 200, is illustrated by the flow chart in FIG. 3 which will now be described with further reference to FIG. 2. FIG. 3 thus illustrates a procedure in the control node 200 to support estimation of path loss and channel response in radio links between multiple wireless devices 204 and an access point 202 of the wireless network. Some optional example embodiments that could be used in this procedure will also be described.

A first action 300 illustrates that the control node 200 assigns a pilot sequence to each wireless device, out of a set of predefined pilot sequences, so that one and the same pilot sequence A is assigned to at least two wireless devices 204, as also shown in operations 2:1A and B of FIG. 2.

In another action 302, the control node 200 further assigns a device-specific phase rotation, R1 and R2 respectively, to each of the at least two wireless devices 204 so that each wireless device assigned with the same pilot sequence is assigned with a phase rotation that is different than the phase rotation(s) assigned to the other wireless device(s), as likewise shown in operations 2:1A and B of FIG. 2. Thereby each wireless device 204 is enabled, or basically configured or instructed, to apply its assigned phase rotation, R1, and R2 respectively, to its assigned pilot sequence A when transmitting the pilot sequence in consecutive coherence intervals.

When employing the procedure of FIG. 3, it is an advantage that it enables path loss and channel response to be estimated on the respective radio links by the access node with high or at least sufficient quality for a pilot reused by two or more wireless devices 204. Further, pilot resources can be saved in the path loss and channel response estimation since path loss can be estimated on the same resources employed for channel response estimation. Further advantages will be mentioned when describing some practical implementation examples later below.

Some further examples of embodiments that may be employed in the above procedure in FIG. 3 will now be described. In some example embodiments, the pilot sequences could be assigned to the wireless devices by providing an associated pilot sequence index to each wireless device, and said device-specific phase rotations could be assigned to the at least two wireless devices assigned with the same pilot sequence by providing an associated phase shift index to each wireless device. These embodiments may be realised so that the above-mentioned indices are transmitted, either jointly or separately, from the access point 202.

In another example embodiment, each device-specific phase rotation may be generated by means of a predetermined function which is known by the access point 202. In another example embodiment, the above-mentioned coherence intervals may be distributed in different resource blocks for uplink transmission, which will be explained in more detail later below.

Another example of how the solution may be employed in terms of actions performed by a wireless device such as the wireless device 204, is further illustrated by the flow chart in FIG. 4 which will now be described likewise with further reference to FIG. 2. FIG. 4 thus illustrates a procedure in the wireless device 204, when in communication with an access point 202 of a wireless network, to support estimation of path loss and channel response in a radio link between the wireless device and the access point. Some optional example embodiments that could be used in this procedure will also be described.

A first action 400 illustrates that the wireless device 204 obtains a pilot sequence assigned to the wireless device out of a set of predefined pilot sequences, as also shown in either of operations 2:2A and 2:2B of FIG. 2, wherein the same (said) pilot sequence is also assigned to at least one other wireless device in communication with said access point. Action 400 also corresponds to action 300.

A further action 402 illustrates that the wireless device 204 also obtains a device-specific phase rotation assigned to the wireless device, as shown in either of operations 2:2A and 2:2B of FIG. 2, said phase rotation being different than a phase rotation assigned to any other wireless device assigned with the same pilot sequence. Action 402 also corresponds to action 302.

In another action 404, the wireless device 204 transmits the obtained pilot sequence in consecutive coherence intervals by applying the obtained phase rotation to the pilot sequence in each coherence interval, as also shown in either of operations 2:3A, B of FIG. 2.

When employing the procedure of FIG. 4, it is likewise an advantage that it enables path loss and channel response to be estimated on the respective radio links by the access node with high or at least sufficient quality for a pilot reused by two or more wireless devices 204. The procedure of FIG. 4 can thus provide the same advantages as the procedure of FIG. 3 since they are related and cooperative in the manner described herein.

Some further examples of embodiments that may be employed in the above procedure in FIG. 4 will now be described. In some example embodiments, the pilot sequence may be obtained by receiving an associated pilot sequence index from the network, and the device-specific phase rotation may be obtained by receiving an associated pilot phase shift index from the network. In these embodiments, the wireless device 204 could receive the above-mentioned indices when transmitted, either jointly or separately, from the access point 202.

In another example embodiment, the obtained pilot sequence may be phase-rotated over said consecutive coherence intervals according to a predetermined function which is also known by the access point 202. In another example embodiment, said coherence intervals may be distributed in different resource blocks for uplink transmission.

Another example of how the solution may be employed in terms of actions performed by an access point such as the access point 202, is further illustrated by the flow chart in FIG. 5 which will now be described likewise with further reference to FIG. 2. FIG. 5 thus illustrates a procedure in the access point 202 when in communication with a wireless device 204, to achieve estimation of path loss and channel response in a radio link between the wireless device and the access point. Some optional example embodiments that could be used in this procedure will also be described.

A first action 500 illustrates that the access point 202 receives a superposition of pilot sequences in consecutive coherence intervals, as also shown in operations 2:3A, B of FIG. 2. the received superposition of pilot sequences includes a phase-rotated pilot sequence assigned to the wireless device and to at least one other wireless device in communication with said access point. Action 500 further corresponds to action 404.

A further action 502 illustrates that the access point 202 de-spreads the pilot sequences received in each coherence interval by projecting the pilot sequences on a set of pre-determined orthonormal sequences. In another action 504, the access point 202 estimates the path loss in the radio link based on the de-spreaded pilot sequences. In a final action 506, the access point 202 estimates the channel response in the radio link based on the estimated path loss. Actions 502-506 correspond to operation 2:4 of FIG. 2.

When employing the procedure of FIG. 5, it is likewise an advantage that the path loss and channel response can be estimated on the respective radio links by the access node with high or at least sufficient quality for a pilot reused by two or more wireless devices 204. The procedure of FIG. 5 can thus provide the same advantages as the procedures of FIG. 3 and FIG. 4 since they are related and cooperative in the manner described herein.

Some further examples of embodiments that may be employed in the above procedure in FIG. 5 will now be described. In one example embodiment, the path loss of the radio link may be estimated by applying a maximum-likelihood function on the received and de-spreaded pilot sequences. This embodiment will be explained further in the examples below.

In another example embodiment, the phase-rotated pilot sequence may be de-rotated using a predetermined phase-rotation sequence. In another example embodiment, said coherence intervals may be distributed in different resource blocks for uplink transmission. In another example embodiment, the wireless network may be a distributed massive Multiple-Input-Multiple-Output, MIMO, network.

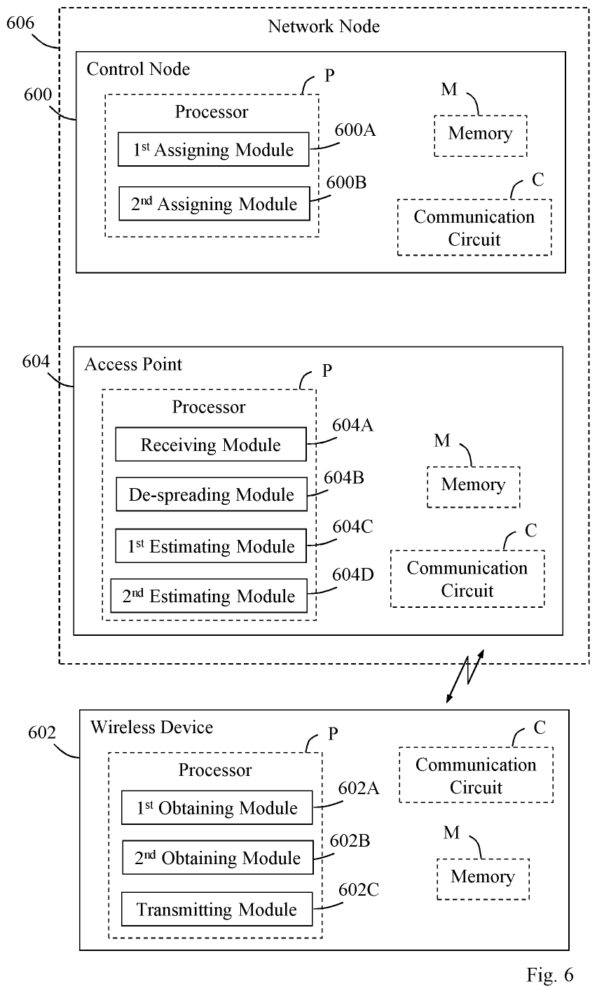

The block diagram in FIG. 6 illustrates a detailed but non-limiting example of how a control node 600, a wireless device 602 and an access point 604, respectively, may be structured to bring about the above-described solution and embodiments thereof. The control node 600 and the access point 604 are assumed to be comprised in a wireless network and could be implemented as separate nodes or in a common node which in that case may be referred to as a network node, as illustrated by a dashed box 606 in FIG. 6.

In this figure, the control node 600, the wireless device 602 and the access point 604 may be configured to operate according to any of the examples and embodiments of employing the solution as described herein, where appropriate. Each of the control node 600, the wireless device 602 and the access point 604 is shown to comprise a processor “P”, a memory “M” and a communication circuit “C” with suitable equipment for transmitting and receiving radio signals in the manner described herein.

The communication circuit C in each of the control node 600, the wireless device 602 and the access point 604 thus comprises equipment configured for communication with each other using a suitable protocol for the communication depending on the implementation. The solution is however not limited to any specific types of messages, signals or protocols.

The control node 600 is, e.g. by means of units, modules or the like, configured or arranged to perform at least some of the actions of the flow chart in FIG. 3 as follows. Further, the wireless device 602 is, e.g. by means of units, modules or the like, configured or arranged to perform at least some of the actions of the flow chart in FIG. 4 as follows. Further, the access node 604 is, e.g. by means of units, modules or the like, configured or arranged to perform at least some of the actions of the flow chart in FIG. 5 as follows.

The control node 600 is arranged to support estimation of path loss and channel response in radio links between wireless devices 604 and an access point 602 of the wireless network. The control node 600 is configured to assign a pilot sequence to each wireless device, out of a set of predefined pilot sequences, so that one and the same pilot sequence is assigned to at least two wireless devices in the set. This assigning operation may be performed by a first assigning module 600A in the control node 600, and as illustrated in action 300.

The control node 600 is also configured to assign a device-specific phase rotation to each of the at least two wireless devices so that each wireless device assigned with the same pilot sequence is also assigned with a phase rotation that is different than the phase rotation(s) assigned to the other wireless device(s). Thereby, each wireless device is enabled and/or instructed to apply its assigned phase rotation to its assigned pilot sequence when transmitting the pilot sequence in consecutive coherence intervals. The latter assigning operation may be performed by a second assigning module 600B in the control node 600, and as illustrated in action 302. The assigning modules 600A, 600B could alternatively be named instructing or configuring modules.

The wireless device 602 is arranged to support estimation of path loss and channel response in a radio link between the wireless device and an access point 602 of a wireless network when in communication with the access point. The wireless device 602 is configured to obtain a pilot sequence assigned to the wireless device out of a set of predefined pilot sequences, wherein the same pilot sequence is also assigned to at least one other wireless device in communication with said access point. This operation may be performed by a first obtaining module 602A in the wireless device 602, and as illustrated in action 400.

The wireless device 602 is also configured to obtain a device-specific phase rotation assigned to the wireless device, said phase rotation being different than a phase rotation assigned to any other wireless device assigned with the same pilot sequence. This operation may be performed by a second obtaining module 602B in the wireless device 602, and as illustrated in action 402. The obtaining modules 602A, 602B could alternatively be named receiving or acquiring modules.

The wireless device 602 is further configured to transmit the obtained pilot sequence in consecutive coherence intervals by applying the obtained phase rotation to the pilot sequence in each coherence interval. This operation may be performed by a transmitting module 602C in the wireless device 602, and as illustrated in action 404. The transmitting module 602C could alternatively be named a sending or pilot module.

The access point 604 is arranged to achieve estimation of path loss and channel response in a radio link between a wireless device 604 and the access point when the access point is in communication with the wireless device. The access point 604 is configured to receive a superposition of pilot sequences in consecutive coherence intervals, including a phase-rotated pilot sequence assigned to the wireless device and to at least one other wireless device in communication with said access point. This operation may be performed by a receiving module 604A in the access point 604, and as illustrated in action 400.

The access point 604 is further configured to de-spread the pilot sequences received in each coherence interval by projecting the pilot sequences on a set of pre-determined orthonormal sequences. This operation may be performed by a de-spreading module 604B in the access point 604, and as illustrated in action 402. The de-spreading module 604C could alternatively be named a signal processing module.

The access point 604 is further configured to estimate the path loss in the radio link based on the de-spreaded pilot sequences. This operation may be performed by a first estimating module 604C in the access point 604, and as illustrated in action 404. The first estimating module 604C could alternatively be named a path loss estimation module.

The access point 604 is further configured to estimate the channel response in the radio link based on the estimated path loss. This operation may be performed by a second estimating module 604D in the access point 604, and as illustrated in action 406. The second estimating module 604D could alternatively be named a channel estimation module. The estimating modules 604C, 604D could also be named determining modules.

It should be noted that FIG. 6 illustrates various functional modules in the control node 600, the wireless device 602 and the access point 604, respectively, and the skilled person is able to implement these functional modules in practice using suitable software and hardware equipment. Thus, the solution is generally not limited to the shown structures of the control node 600, the wireless device 602 and the access point 604, and the functional modules therein may be configured to operate according to any of the features, examples and embodiments described in this disclosure, where appropriate.

The functional modules 600A-B, 602A-C and 604A-D described above may be implemented in the control node 600, the wireless device 602 and the access point 604, respectively, by means of program modules of a respective computer program comprising code means which, when run by the processor P causes the control node 600, the wireless device 602 and the access point 604 to perform the above-described actions and procedures. Each processor P may comprise a single Central Processing Unit (CPU), or could comprise two or more processing units. For example, each processor P may include a general purpose microprocessor, an instruction set processor and/or related chips sets and/or a special purpose microprocessor such as an Application Specific Integrated Circuit (ASIC). Each processor P may also comprise a storage for caching purposes.

Each computer program may be carried by a computer program product in each of the control node 600, the wireless device 602 and the access point 604 in the form of a memory having a computer readable medium and being connected to the processor P. The computer program product or memory M in each of the control node 600, the wireless device 602 and the access point 604 thus comprises a computer readable medium on which the computer program is stored e.g. in the form of computer program modules or the like. For example, the memory M in each node may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the respective control node 600, wireless device 602 and access point 604.

The solution described herein may be implemented in each of the control node 600, the wireless device 602 and the access point 604 by a computer program comprising instructions which, when executed on at least one processor, cause the at least one processor to carry out the actions according to any of the above embodiments and examples, where appropriate. The solution may also be implemented at each of the control node 600, the wireless device 602 and the access point 604 in a carrier containing the above computer program, wherein the carrier is one of an electronic signal, optical signal, radio signal, or computer readable storage medium.

Some non-limiting but illustrative examples of how the above-described procedures and apparatuses may be employed in practice will now be described. The terms “UE” and “user” are frequently used below as synonyms for wireless device. Further, UL denotes uplink and DL denotes downlink. First, some issues associated with current conventional solutions and procedures will be discussed.

For example, beamforming in distributed so-called massive Multiple-Input-Multiple-Output (MIMO) technology relies on accurate knowledge of channel responses in radio links between wireless devices and access points. Obtaining high-quality channel estimates in turn requires the path losses in the radio links between terminals and access points to be known. These path losses may change rapidly, especially in line-of-sight environments with moving blocking objects and/or moving devices. One difficulty in the estimation of path losses as discussed above is pilot contamination where pilots simultaneously transmitted from different terminals may add up destructively or constructively by chance, seriously affecting the estimation quality and hence the eventual communication performance.

Procedures and apparatuses for enabling or achieving estimation of path losses, along with an accompanying pilot transmission scheme, are disclosed herein which may be useful in terms of both Rayleigh fading and line-of-sight blocking, which can significantly improve performance over current conventional solutions. By employing phase-rotated pilots transmitted from wireless devices in consecutive coherence intervals, e.g. distributed in different resource blocks according to a pre-determined function known to all parties, an effective statistical distribution of the received pilot signals is created that can be efficiently exploited by the path loss and channel response estimations described herein.

In distributed massive MIMO, also referred to as “cell-free massive MIMO” in this field, many geographically distributed Access Points (APs) simultaneously serve many UEs through coherent beamforming. In its canonical form, this technology relies on uplink pilots transmitted by the UEs in order to estimate all UE-to-AP uplink channel responses. These estimates can then be used to aid decoding of uplink data, and by virtue of reciprocity of propagation in Time Division Duplex, subsequently for downlink beamforming.

So-called radio stripes can be employed in an implementation of distributed massive MIMO. Specifically, the actual APs could comprise antenna elements and circuit-mounted chips, e.g. including power amplifiers, phase shifters, filters, modulators, ND and D/A converters, which are embedded inside a protective casing of a cable or a stripe. Each radio stripe is then connected to one or multiple CPUs. Since the total number of distributed antennas is assumed to be large, the transmit power of each antenna can be very low, resulting in low heat-dissipation, small volume and weight, and low cost.

The receive/transmit processing of an antenna is performed right next to the antenna. On the transmitter side, each AP receives multiple streams of input data from a previous AP via a shared bus, e.g., one stream per UE, one UE with multiple streams, or some other UE-stream allocation. In each AP, the input data streams are scaled with the pre-calculated precoding vector and the sum-signal is transmitted over the radio channel to the receiver(s). By exploiting channel reciprocity, a precoding vector used in the downlink may be a function of the estimated uplink channels. On the receiver side, the received radio signal is multiplied with the combining vector previously calculated in the uplink pilot phase. The output gives data streams that are then combined with the data streams received from the shared bus and sent again on the shared bus to the next AP. The radio stripe system can basically facilitate or enable a flexible and low-cost cell-free Massive MIMO deployment.

Some problems associated with current solutions for massive MIMO will now be discussed.

Accurate channel estimation is vital in distributed massive MIMO. Without it, pre-coding coefficients for UL and DL data transmission cannot be accurately calculated and the performance can quickly become poor.

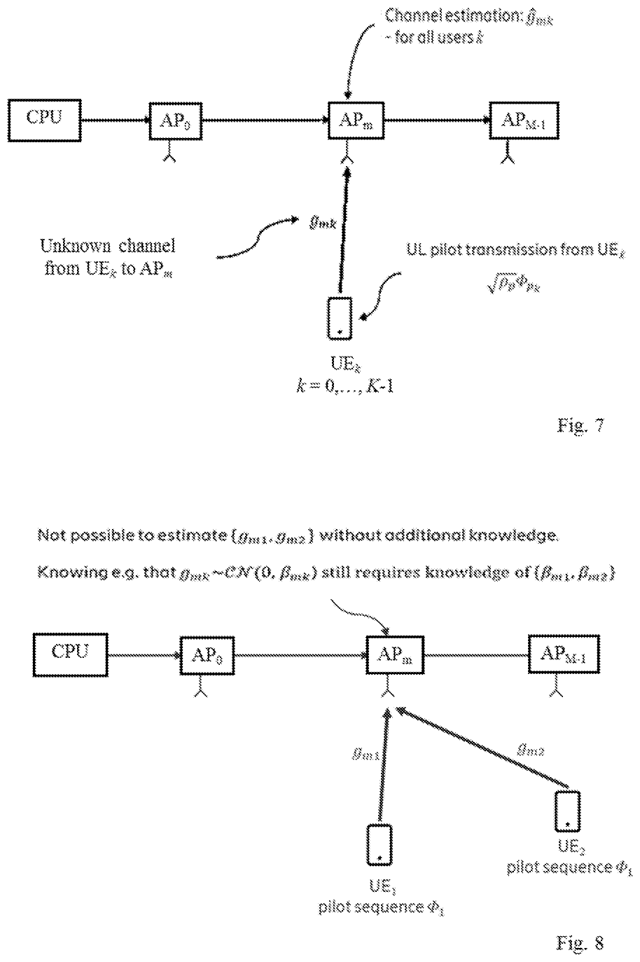

FIG. 7 basically illustrates a system model of a distributed massive MIMO system comprising a CPU, several APs, serving several UEs, which system model will be referred to below.

Let gₘₖ be the scalar channel response between AP m (APₘ) and user equipment k (UEₖ), as illustrated in FIG. 7. Single-antenna APs are assumed for the sake of simplifying this description. The discussion below can be generalized to multi-antenna APs.

Channel estimation is based on UL pilot transmission from the UEs and a set of τₚ pre-determined orthonormal sequences {φ₁, . . . φ_{τ}_{ₚ}} are used as pilots. User k is assigned a pilot sequence φₚ_{ₖ} (with pilot sequence index pₖ) and \sqrt{ρₚ} denotes the normalized power of the UL pilot.

The usual assumption is that {gₘₖ}, m=0, . . . , M−1; k=0, . . . , K−1, are statistically independent, complex Gaussian with zero mean and known variances βₘₖ=var(gₘₖ) that represent the average channel path losses, including large-scale shadowing effects. This assumption corresponds to Rayleigh small-scale fading.

Methods typically used for channel estimation in the literature are based on Bayesian Minimum-Mean Square Error (MMSE) estimation. MMSE estimation requires a priori assumptions to be made on the statistics of the channel responses, specifically, the path loss, i.e. the βₘₖ values, between every AP m and every UE k in the network need to be known.

There is no known way around the assumption that the path losses are known, other than to use special training data to estimate these path losses, which estimation requires the expense of significant extra resources. These resources may be simply unavailable, especially in applications that require ultra-low latency, and in applications for bandwidth-constrained massive Machine-Type Communications (mMTC). A complication in this estimation is that pilots are typically reused because of finite channel coherence, which inevitably introduces pilot contamination, causing interference that is hard to resolve without a priori information, see FIG. 8 which illustrates two UEs (UE₁ and UE₂) using the same pilot sequence (φ₁), in the scenario of FIG. 7. Furthermore, the entire notion of a Gaussian prior on {gₘₖ} requires stationarity, that is, constancy of {βₘₖ} over time and frequency, which is an assumption that is likely to be violated in practice. For example, a fast-moving blocking object and/or the UE itself moving behind a blocking object may abruptly change the path loss, especially when higher carrier frequencies are used for signal transmissions. In conclusion, the stationarity assumption and the associated requirement of prior knowledge of {βₘₖ} can be hampering in a practical implementation.

It might be tempting to use other algorithms than MMSE for the estimation of {gₘₖ}, that do not require any prior assumptions, such as least-square based algorithms. However, that could result in very poor estimation performance unless appropriate post-processing of the received data is used, post-processing which in turn requires knowledge of {βₘₖ}. The reason is that {βₘₖ} contain a significant amount of information—in fact, the information encoded in {βₘₖ} be interpreted as a priori information on the UE locations. A UE k close to an AP m will have a large value of {βₘₖ}, and conversely a UE k far away from an AP m will have a small value of {βₘₖ}.

Herein a solution is disclosed which can be used to estimate the channel responses {gₘₖ} and the path losses {βₘₖ} in the presence of pilot contamination, along with an accompanying phase-shifting pilot transmission scheme. The solution is for example useful in line-of-sight operation, which is likely to be the most common operating condition for distributed massive MIMO systems. The solution could also be useful in scenarios where (i) the stationarity assumption does not hold because of fast-changing blocking conditions, (ii) at higher carrier frequencies, (iii) where latency is a concern, and (iv) the allocated bandwidth is small e.g., in certain mMTC and Internet of Things (IoT) scenarios.

An example system model where the embodiments herein can be used will now be described. The following data and information are assumed to be valid in this model.

K single-antenna UEs are served through coherent beamforming by M service antennas. These M service antennas are deployed on APs. An AP may have a single antenna, or (small) arrays of antennas; the precise arrangement is substantially immaterial for the modeling and only affects the eventual performance. Note that, for simplicity, it is assumed in this discussion that single-antenna APs and single-antenna UEs are used. Generalization to multi-antenna APs and UEs can be readily made. It can also be assumed there is full coherent cooperation among all N service antennas.

The channel coherence block, also denoted coherence interval, includes τ_{c} samples of which τₚ are used for uplink pilots. A set of τₚ pre-determined orthonormal sequences (τₚ vectors) {φ₁, . . . , φ_{τ}_{ₚ}} are used as pilots. The case of interest is when K>τₚ, so that reuse of pilots among different UEs is inevitable. The transmission in I coherence intervals is considered.

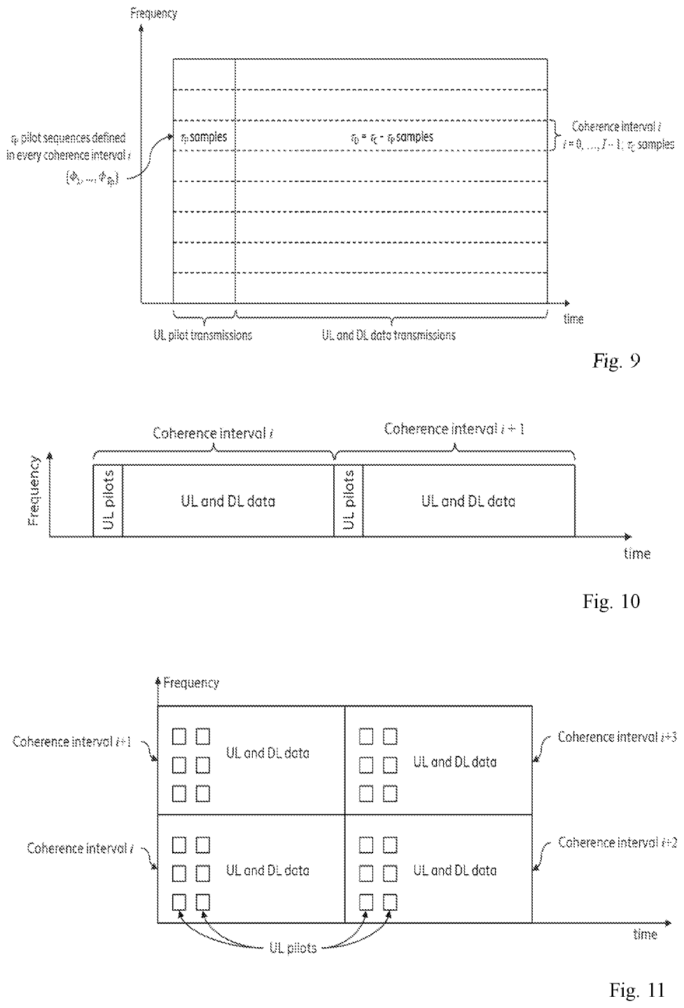

It should be noted that coherence intervals can be defined in many different ways, some examples of how coherence intervals can be distributed in resource blocks are depicted in FIGS. 9-11. In more detail, FIG. 9 illustrates an example where the coherence intervals are distributed in the frequency domain, FIG. 10 illustrates an example where coherence intervals are distributed in the time domain, and FIG. 11 illustrates an example where coherence intervals are distributed in both the frequency domain and the time domain.

It can be noted that one coherence interval contains one set of resources used for channel estimation (τₚ samples) which can be spread out within the coherence interval in an arbitrary manner. The coherence interval also contains a set of resources used for uplink and downlink data transmission. It can be further noted that there may also be other signals defined in a coherence interval not depicted in any of the figures below e.g. downlink pilots, synchronization signals, channel state information reference signals, system information signals, etc.

In a low-latency application, these coherence intervals would comprise groups of subcarriers of a single OFDM symbol in time—though nothing precludes the I intervals to span over multiple OFDM symbols in principle. Only the uplink is of concern here, and mₘᵢₖ denotes the channel between UE k and AP m in coherence interval i. For the purpose of channel estimation, the K UEs transmit uplink pilots.

It will now be described how the access node may operate when receiving the pilots transmitted by the K UEs.

In each coherence interval, AP m receives a linear superposition of K pilots and performs de-spreading, e.g. according to a standard manner, by projecting this received pilot signal onto the orthonormal pilot vectors {φₚ}. This de-spreading results in Iτₚ random variables in each AP,

y_{miq}=\sqrt{ρₚ}Σ_{k:p}_{ₖ}_{=q}gₘᵢₖ+w_{miq},m=0, . . . ,M−1;i=0, . . . ,I−1;q=0, . . . ,τₚ−1

where τₚ is a constant that, as mentioned earlier, has the interpretation of pilot Signal-to-Noise Ratio (SNR). Each variable, y_{miq}, contains the received pilot at the m^{th} AP in the i^{th} coherence interval projected onto the CIA pilot sequence. The sum is over those UEs that use the q^{th} pilot sequence, and this summation arises because of the pilot reuse. (If each UE had a unique pilot sequence, then Σ_{k:p}_{ₖ}_{=q}gₘᵢₖ would reduce to gₘᵢₖ′ where k′ is the index of the UE that uses pilot q.) The terms {w_{miq}} contain noise and are assumed to be mutually independent [symbol] (0,1).

For a given pilot sequence index q, the variables {y_{miq}} constitute a sufficient statistic for the estimation of all film {gₘᵢₖ} for which pₖ=q. However, without the use of additional prior knowledge, estimates based on {y_{miq}} are typically meaningless. One issue is evidently that the AP sees the (reused) pilots superimposed, and without a priori information it has no way of telling which contribution to y_{miq} is originated from a specific UE.

It will now be described how path loss {βₘₖ} can be estimated for radio links.

A solution is provided to estimate the path losses {βₘₖ} from pilot-contaminated observations that are useful irrespective of the channel fading distribution. In this example, the following operations 1-4 are performed:
1) UEs transmitting structured phase-rotated pilot sequences over different resource blocks (according to a pre-determined function established by the APs in a centralized or distributed fashion in advance). Pilot sequences are reused among the UEs.
2) AP in estimating the path losses towards the K UEs, i.e., {βₘₖ}, through maximum-likelihood under a suitable assumption on {gₘᵢₖ}. Let L_{miq} be the contribution to the logarithm of the likelihood function, with respect to the measurement |y_{miq}|² in coherence interval i for pilot q. These contributions are then summed up over the coherence blocks in order to find the maximum-likelihood estimates of {βₘₖ}.
3) APs estimating the channel responses and decoding the data using the so-obtained path loss estimates (using methods from state-of-the-art).
4) APs de-rotating the channel responses by using the predetermined phase-rotation sequences.

UE k is assigned with a pilot sequence index p and a pilot phase shift index sₖ. Then, each UE applies I phase-rotations to its own assigned pilot, according to a pre-determined function known to all APs and depending on k, resulting in unique phase-shifted pilot sequences. The I phase-rotated pilots are then transmitted in I consecutive coherence blocks. The transmitted pilot from UEₖ in coherence interval i can e.g. be defined as

\sqrt{ρₚ}φₚ_{ₖ}^{e}^{^{jφ}}^{ik},

where the deterministic phase shifting function may be defined as

$${φ}_{ik} = \frac{2 π ( iK + {s}_{k} )}{IK} ,$$

where sₖ∈{0, 1, . . . , K−1}, is a network configured phase-shifting index assigned to user k.

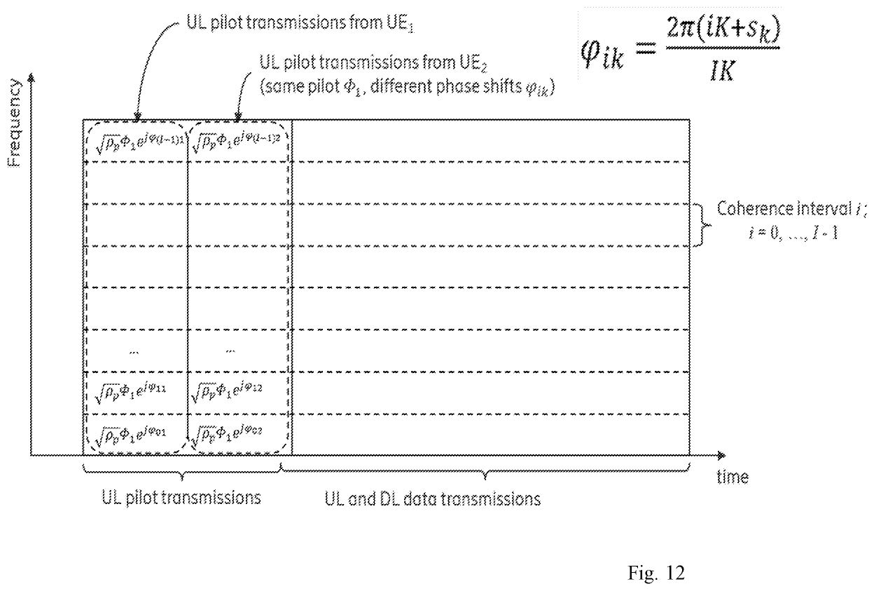

It can be noted that instead of describing this as user k transmitting the shifted pilot sequence φₚ_{ₖ}^{e}^{^{jφ}}^{ik} in coherence interval i, this can equally be viewed as a “sequence expansion” operation. This can be started with the pilot sequence for user k, i.e. φₚ_{ₖ}. An expanded set of sequences {φₚ_{ₖ}^{e}^{^{jφ}}^{1k}, φₚ_{ₖ}^{e}^{^{jφ}}^{2k}, . . . , φₚ_{ₖ}^{e}^{^{jφ}}^{ik}} can then be defined and pᵢₖ can be defined as the index of the pilot sequence in this expanded set. Both these descriptions are equivalent, see FIG. 12 which illustrates an example where phase shifted pilot sequences are transmitted from two UEs using the same pilot sequence.

In the following, pₖ will be used to denote the index to the pilot in the original set of pilot sequences and pᵢₖ will be used to denote the index to the pilot sequence in the expanded set.

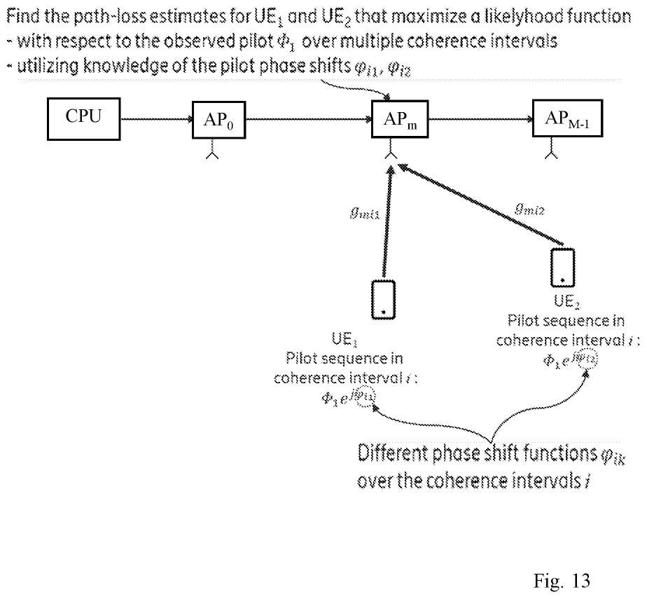

By phase-shifting the pilots deterministically over the coherence intervals, it is ensured that channel estimation is feasible even in the case when two UEs use the same pilot sequence, see FIG. 13 which illustrates an example where two UEs using the same pilot sequence are using different phase shift functions, i.e. phase rotations.

The purpose of applying these structured phase-rotations to the transmitted pilot sequence is to approximately de-correlate the channels of different UEs in different coherence blocks, i.e. coherence intervals. This de-correlation facilitates the channel estimation. In scenarios where the UEs' channels are uncorrelated, e.g., at independent Rayleigh fading channels, phase-rotated pilots might not introduce significant benefits. Conversely, in line-of-sight operation, which is likely to be the most common operating condition for distributed massive MIMO, channels are highly correlated, and the benefits provided by the proposed scheme are substantial, as will be shown below.

Another solution has been suggested where UEs transmit pseudo-random phase-shifted pilot sequences in resources dedicated to covariance channel matrix estimation. With respect to this previous scheme, the embodiments herein may provide better estimation performance and the saving of pilot resources for the path loss estimation, whereas the above previous scheme requires additional dedicated resources for estimating the path losses. In the embodiments herein, the path losses are estimated in the same resources employed for the channel response estimation.

It will now be described how the channel responses {gₘₖ} can be estimated using the MMSE method, also referred to as the MMSE estimator.

The path loss estimates obtained as above can be exploited as prior information to estimate the channel responses by using, for example, an MMSE estimator.

An acknowledged assumption made in prior solutions assumes that a priori, {gₘᵢₖ} are statistically independent gₘᵢₖ˜CN(0,βₘₖ), i=0, . . . , I−1, where βₘₖ is constant at least over I coherence blocks and known, from which the MMSE estimate can be made as follows:

$${\hat{g}}_{mik} = E \{ {g}_{mik} \vert \{ {y}_{mi 1} , … , {y}_{mi {τ}_{p}} \} \} = E \{ {g}_{mik} \vert {y}_{{mip}_{ik}} \} = \frac{\sqrt{{ρ}_{p}} {β}_{mk}}{{ρ}_{p} {\sum }_{{k}^{′} : {p}_{{k}^{′}} = {p}_{k}}^{K} {β}_{{mk}^{′}} + 1} {y}_{mik}$$

These estimates {ĝₘᵢₖ} are optimal if the channels have the distribution gₘᵢₖ˜CN(0,βₘₖ), and sub-optimal otherwise. They are typically useful also for other fading distributions (Ricean, line-of-sight, for example) as long as βₘₖ has the meaning of average strength (mean-square value) of gₘᵢₖ.

It will now be described how pilot sequences and phase rotations can be configured, which may be useful when implementing the embodiments herein.

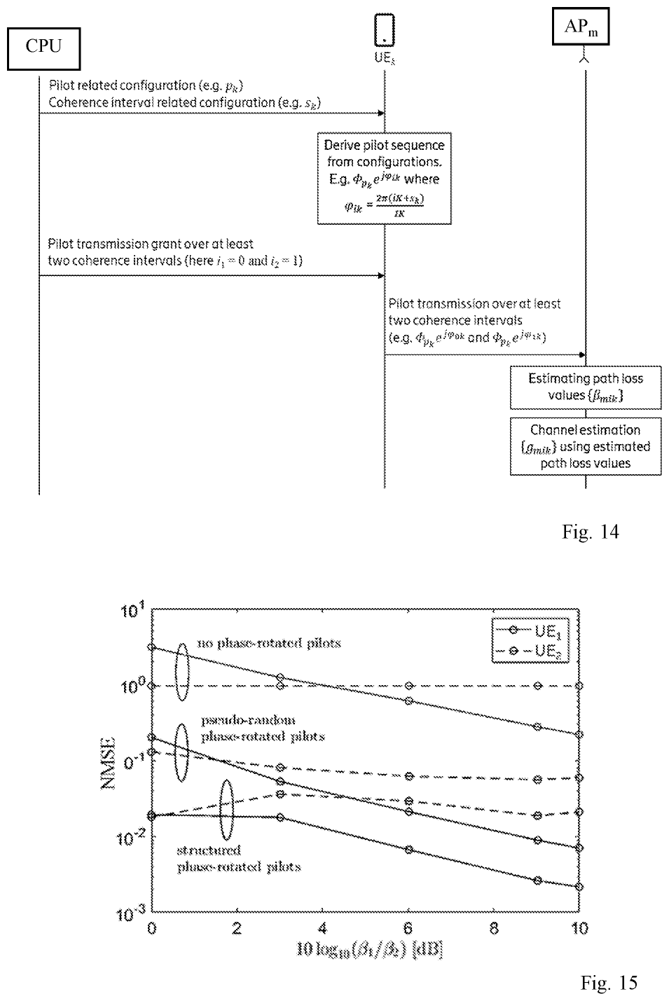

For the UE to be able to transmit phase rotated pilot sequences in accordance with the embodiments herein, the UE need to be configured with some information. It may be assumed that the configuration of UEs is coordinated in a Central Processing Unit (CPU). The UE receives over the radio, i.e. via the APs, at least a pilot configuration, e.g. in the form of a pilot sequence index pₖ, and a configuration describing the phase shift operation over the intervals, e.g. a phase shift index s, see FIG. 14 which illustrates operations and messages of a UE, an AP and a CPU to accomplish configuration of the UE and estimation of path loss and channel response. When receiving a grant or a command to transmit an UL pilot over at least two coherence intervals, the UE performs the pilot transmissions in accordance with these configurations.

Another example will now be described where pilots transmitted from two UEs collide in a line-of-sight scenario.

In line-of-sight, we have |gₘ₁ₖ|= . . . =|gₘₗₖ=\sqrt{βₘₖ} and the phase of gₘᵢₖ is either constant or varies linearly with i. The pilot signal transmitted by UE k in coherence interval i is multiplied by a factor e^{jφ}^{ᵢₖ}, where {φᵢₖ} is a set of deterministic variables that approximately de-correlate gₘᵢₖ, and g_{mi′k′} for i′≠i or k′≠k. This set is generated by a built-in function established by the CPU and known at the APs. Let us assume two UEs, k={1,2}, in line-of-sight towards AP m, simultaneously transmitting the same pilot sequence with index q. AP m receives in the coherence block i the pilot signal and the AP observes

|y_{miq}|²=|\sqrt{ρₚ}e^{jφ}^{ᵢ₁}gₘᵢ₁+\sqrt{ρₚ}e^{jφ}^{ᵢ₂}gₘᵢ₂+w_{miq}|²

where φᵢₖ is a real value between 0 and 2π. For example, the phase shift of a UE k in coherence block I can then be generated from the following built-in function:

$${φ}_{ik} = \frac{2 π ( iK + {s}_{k} )}{IK} , i = 0 , 1 , … , I - 1 , {s}_{k} = 0 , … , K - 1.$$

In this example, the AP m needs to estimate the path losses βₘ₁ and βₘ₂. Hence, it computes the log-likelihood function with respect to the observation |y_{miq}|², that is

L_{miq}(βₘ₁,βₘ₂=log p(|y_{miq}|²;βₘ₁,βₘ₂)

where p(|y_{miq}|²;βₘ₁,βₘ₂) is the probability density function of |y_{miq}|² parametrized in βₘ₁ and βₘ₂. The path losses are thus estimated through maximum likelihood by doing

$${\hat{β}}_{m 1} , {\hat{β}}_{m 2} = {argmax}_{{β}_{m 1} , {β}_{m 2}} {{\sum }_{i}}^{I} {L}_{miq} ( {β}_{m 1} , {β}_{m 2} )$$

The path loss estimates \hat{β}ₘₖ are then used to calculate the channel estimates {ĝₘᵢₖ}, e.g., by performing the MMSE method as described above. The channel estimates can then be de-rotated by multiplying them by e^{-jφ}^{ᵢₖ}.

To evaluate the performance improvement that can be achieved by using the embodiments herein, an example may be considered where an AP m estimates the path losses towards two UEs (UE₁ and UE₂, respectively) which share the same pilot sequence. The AP observes ten coherence intervals (CIs) in this example in which the UEs simultaneously send phase-shifted versions of the same pilot, hence causing pilot contamination. The effect of phase-rotating the pilot sequence at each coherence interval is shown in FIG. 15. It may be assumed that the path loss of EU₁ (reference path loss) is fixed and the path loss of UE₂ can vary from 0 to 10 dB larger than the reference path loss. For each value of EU₂'s path loss, the Normalized Mean Square Error (NMSE) of the path loss estimate is then measured, at the UE k, defined as:

$${NMSE}_{k} = \frac{E \{ {\vert {\hat{β}}_{mk} - {\hat{β}}_{mk} \vert}^{2} \}}{{β}_{mk}^{2}}$$

where \hat{β}ₘₖ is the estimate of βₘₖ. FIG. 15 thus shows the resulting NMSE of the path loss estimates according to three schemes a-c including a) with structured phase-rotated pilot transmission in accordance with the embodiments herein, b) with pseudo-random phase-rotated pilot transmission according to the above-described prior solution and c) with no phase rotation of the pilot.

The path loss estimates in all the schemes of FIG. 15 are obtained by using the procedure described above. As can be seen from these results, the NMSE achieved by employing the embodiments herein (a) is significantly smaller than that achieved by the two other prior schemes. Hence, phase-rotating the pilot sequence deterministically at each coherence block yields better path loss estimates than what can be achieved by using current conventional solutions and methods.

While the solution has been described with reference to specific exemplifying embodiments, the description is generally only intended to illustrate the inventive concept and should not be taken as limiting the scope of the solution. For example, the terms “control node”, “wireless device”, “access point”, “pilot sequence”, “phase rotation”, “coherence interval”, “index” and “de-spreading” have been used throughout this disclosure, although any other corresponding entities, functions, and/or parameters could also be used having the features and characteristics described here. The solution may be implemented according to the appended embodiments.

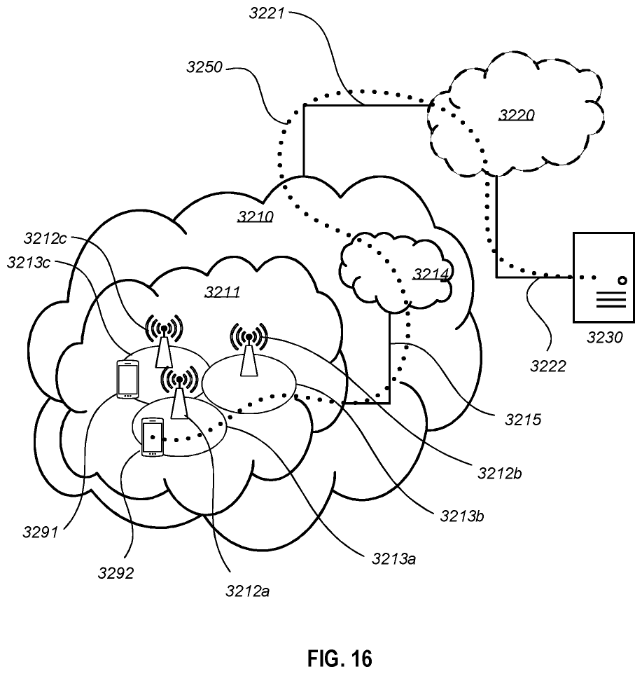

Some further extensions and variations will now be described with reference to FIGS. 16-21.

With reference to FIG. 16, in accordance with an embodiment, a communication system includes a telecommunication network 3210 e.g. a WLAN, such as a 3GPP-type cellular network, which comprises an access network 3211, such as a radio access network, and a core network 3214. The access network 3211 comprises a plurality of base stations 3212a, 3212b, 3212c, such as access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 16 as a whole enables connectivity between one of the connected UEs 3291, 3292 and the host computer 3230. The connectivity may be described as an over-the-top (OTT) connection 3260. The host computer 3230 and the connected UEs 3291, 3292 are configured to communicate data and/or signaling via the OTT connection 3260, using the access network 3211, the core network 3214, any intermediate network 3220 and possible further infrastructure (not shown) as intermediaries. The OTT connection 3260 may be transparent in the sense that the participating communication devices through which the OTT connection 3260 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

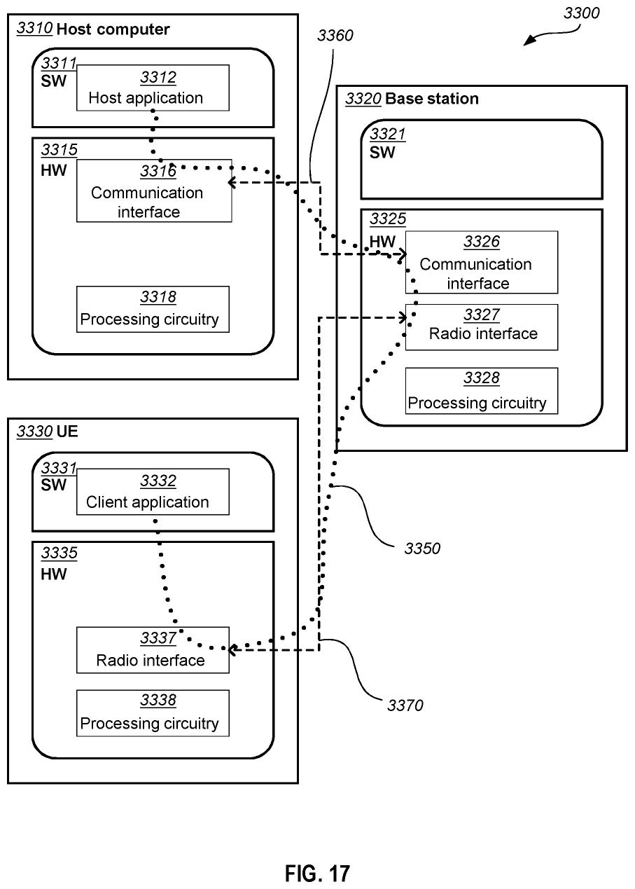

Example implementations, in accordance with an embodiment, of the UE, base station and host computer discussed in the preceding paragraphs will now be described with reference to FIG. 17. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3360 terminating at the UE 3330 and the host computer 3310. In providing the service to the remote user, the host application 3312 may provide user data which is transmitted using the OTT connection 3360.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 17) served by the base station 3320. The communication interface 3326 may be configured to facilitate a connection 3360 to the host computer 3310. The connection 3360 may be direct or it may pass through a core network (not shown in FIG. 17) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3360 terminating at the UE 3330 and the host computer 3310. In providing the service to the user, the client application 3332 may receive request data from the host application 3312 and provide user data in response to the request data. The OTT connection 3360 may transfer both the request data and the user data. The client application 3332 may interact with the user to generate the user data that it provides.

It is noted that the host computer 3310, base station 3320 and UE 3330 illustrated in FIG. 17 may be identical to the host computer 3230, one of the base stations 3212a, 3212b, 3212c and one of the UEs 3291, 3292 of FIG. 16, respectively. This is to say, the inner workings of these entities may be as shown in FIG. 17 and independently, the surrounding network topology may be that of FIG. 16.

In FIG. 17, the OTT connection 3360 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3360 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3360, in which the wireless connection 3370 forms the last segment. More precisely, the teachings of these embodiments may improve the efficiency in communication and thereby provide benefits such as better utilization of resources in the network.

A measurement procedure may be provided for the purpose of monitoring data rate, latency and other factors on which the one or more embodiments improve. There may further be an optional network functionality for reconfiguring the OTT connection 3360 between the host computer 3310 and UE 3330, in response to variations in the measurement results. The measurement procedure and/or the network functionality for reconfiguring the OTT connection 3360 may be implemented in the software 3311 of the host computer 3310 or in the software 3331 of the UE 3330, or both. In some embodiments, sensors (not shown) may be deployed in or in association with communication devices through which the OTT connection 3360 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3360 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3360 while it monitors propagation times, errors etc.

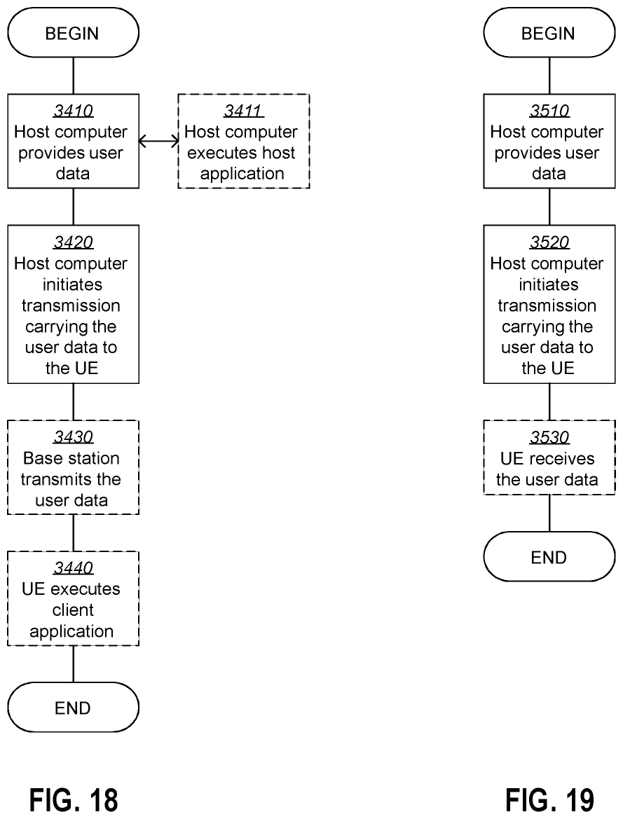

FIG. 18 is a flowchart illustrating a method implemented in a communication system, in accordance with one embodiment. The communication system includes a host computer, a base station such as a AP STA, and a UE such as a Non-AP STA which may be those described with reference to FIGS. 16 and 17. For simplicity of the present disclosure, only drawing references to FIG. 18 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 19 is a flowchart illustrating a method implemented in a communication system, in accordance with one embodiment. The communication system includes a host computer, a base station such as a AP STA, and a UE such as a Non-AP STA which may be those described with reference to FIGS. 16 and 17. For simplicity of the present disclosure, only drawing references to FIG. 19 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

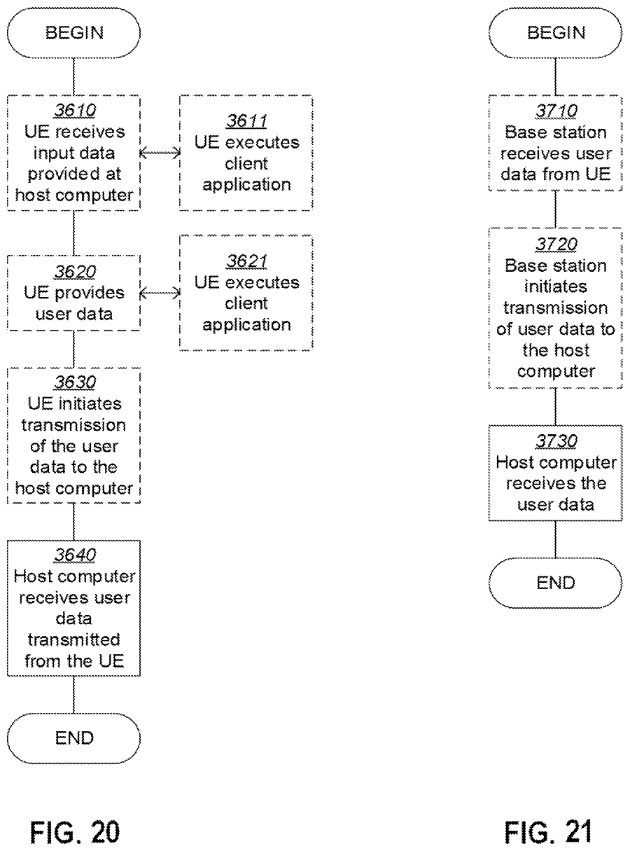

FIG. 20 is a flowchart illustrating a method implemented in a communication system, in accordance with one embodiment. The communication system includes a host computer, a base station such as a AP STA, and a UE such as a Non-AP STA which may be those described with reference to FIGS. 16 and 17. For simplicity of the present disclosure, only drawing references to FIG. 20 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station such as a AP STA, and a UE such as a Non-AP STA which may be those described with reference to FIGS. 16 and 17. For simplicity of the present disclosure, only drawing references to FIG. 21 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1. A method performed by a control node of a wireless network, to support estimation of path loss and channel response in radio links between wireless devices and an access point of the wireless network, the method comprising:
assigning a pilot sequence to each wireless device, out of a set of predefined pilot sequences, by providing an associated pilot sequence index to each wireless device, so that one and the same pilot sequence is assigned to at least two wireless devices; and
assigning a device-specific phase rotation to each of the at least two wireless devices, by providing an associated pilot sequence index to each wireless device, so that each wireless device assigned with the same pilot sequence is assigned with a phase rotation that is different than the phase rotation(s) assigned to the other wireless device(s), thereby enabling each wireless device to apply its assigned phase rotation to its assigned pilot sequence when transmitting the pilot sequence in consecutive coherence intervals.

2. (canceled)

3. The method according to claim 1, wherein each device-specific phase rotation is generated by means of a predetermined function which is known by the access point.

4. The method according to claim 1, wherein the coherence intervals are distributed in different resource blocks for uplink transmission.

5. A control node of a wireless network, the control node being arranged to support estimation of path loss and channel response in radio links between wireless devices and an access point of the wireless network, the control node being configured to:
assign a pilot sequence, by providing an associated pilot sequence index to each wireless device, out of a set of predefined pilot sequences, so that one and the same pilot sequence is assigned to at least two wireless devices in the set; and
assign a device-specific phase rotation to each of the at least two wireless devices, by providing an associated phase shift index to each wireless device, so that each wireless device assigned with the same pilot sequence is assigned with a phase rotation that is different than the phase rotation(s) assigned to the other wireless device(s), thereby enabling each wireless device to apply its assigned phase rotation to its assigned pilot sequence when transmitting the pilot sequence in consecutive coherence intervals.

6. (canceled)

7. The control node according to claim 5, wherein the control node is configured to generate each device-specific phase rotation by means of a predetermined function which is known by the access point.

8. The control node according to claim 5, wherein the coherence intervals are distributed in different resource blocks for uplink transmission.

9. A method performed by a wireless device in communication with an access point of a wireless network, to support estimation of path loss and channel response in a radio link between the wireless device and the access point, the method comprising:
obtaining a pilot sequence assigned to the wireless device out of a set of predefined pilot sequences, by receiving an associated pilot sequence index from the network, wherein the same pilot sequence is also assigned to at least one other wireless device in communication with the access point;
obtaining a device-specific phase rotation assigned to the wireless device, by receiving an associated pilot phase shift index from the network, the phase rotation being different than a phase rotation assigned to any other wireless device assigned with the same pilot sequence; and
transmitting the obtained pilot sequence in consecutive coherence intervals by applying the obtained phase rotation to the pilot sequence in each coherence interval.

10. (canceled)

11. The method according to claim 9, wherein the obtained pilot sequence is phase-rotated over the consecutive coherence intervals according to a predetermined function which is also known by the access point.

12. The method according to claim 9, wherein the coherence intervals are distributed in different resource blocks for uplink transmission.

13. A wireless device arranged to support estimation of path loss and channel response in a radio link between the wireless device and an access point of a wireless network when in communication with the access point, the wireless device being configured to:
obtain a pilot sequence assigned to the wireless device out of a set of predefined pilot sequences, by receiving an associated pilot sequence index from the network, wherein the same pilot sequence is also assigned to at least one other wireless device in communication with the access point;
obtain a device-specific phase rotation assigned to the wireless device, by receiving an associated pilot phase shift index form the network, the phase rotation being different than a phase rotation assigned to any other wireless device assigned with the same pilot sequence; and
transmit the obtained pilot sequence in consecutive coherence intervals by applying the obtained phase rotation to the pilot sequence in each coherence interval.

14. (canceled)

15. The wireless device according to claim 13, wherein the wireless device is configured to phase-rotate the obtained pilot sequence over the consecutive coherence intervals according to a predetermined function which is also known by the access point.

16. The wireless device according to claim 13, wherein the coherence intervals are distributed in different resource blocks for uplink transmission.

17.-28. (canceled)
